(19) United States
(12) Patent Application Publication
(10) Pub. No.: US 2014/0327646 A1
(43) Pub. Date: Nov. 6, 2014

(54) TOUCH DEVICE AND MEASURING VOLTAGE DYNAMIC ADJUSTMENT METHOD THEREOF

(71) Applicant: ELAN MICROELECTRONICS CORPORATION, Hsinchu (TW)

(72) Inventors: I-Hau YEH, Taipei City (TW); Bo-Syuan HUANG, Taichung City (TW); Hsueh-Wei YANG, Taoyuan City (TW); Yung Lieh CHIEN, Taoyuan City (TW)

(73) Assignee: ELAN MICROELECTRONICS CORPORATION, Hsinchu (TW)

(21) Appl. No.: 14/212,030

(22) Filed: Mar. 14, 2014

(30) Foreign Application Priority Data
May 3, 2013 (TW) 102115813

(51) Int. Cl. G06F 3/044

(52) U.S. Cl. CPC G06F 3/044
USPC 345/174

(57) ABSTRACT

A touch device and a measuring voltage dynamic adjustment method thereof are provided. The touch device comprises a touch panel, a touch sensing circuit and a processing unit. The touch sensing circuit electrically connected to the touch panel is configured to provide a measuring voltage to the touch panel and sense the touch panel to generate a sensing signal. The processing unit electrically connected to the touch sensing circuit is configured to receive the sensing signal, calculate a first ratio according to the sensing signal and dynamically adjust the measuring voltage according to the first ratio.

This application claims the benefit of priority based on Taiwan Patent Application No. 102115813 filed on May 3, 2013, which is hereby incorporated by reference in its entirety.

### CROSS-REFERENCES TO RELATED APPLICATIONS

Not applicable.

### BACKGROUND OF THE INVENTION

1. Field of the Invention

The present invention relates to a touch device and a measuring voltage dynamic adjustment method thereof, and more particularly, relates to a touch device that can dynamically adjust a measuring voltage of a touch sensing circuit according to a sensing signal received from the touch sensing circuit.

2. Descriptions of the Related Art

Owing to advancement of the displaying technologies, operating a touch device (e.g., a personal digital assistant (PDA), a tablet computer, a digital video camera, information appliances, a mobile phone and etc) through touching has become very common. For touch panels of the touch devices, capacitive touch panels are widely used.

Currently in the touch devices, an invariable measuring voltage is provided to the capacitive touch panel. However, the magnitude of the measuring voltage has a direct influence on performances of the touch devices. Generally speaking, the touch devices provide a relatively low measuring voltage for scanning operations in order to save power, but a too low measuring voltage also makes the measured sensing signal susceptible to interferences from noises, which may lead to false determination of the touch position or instructions. On the other hand, a high measuring voltage can effectively suppress the interferences from noises, but this drives the power consumption of the touch devices higher.

Accordingly, an urgent need still exists in the art to provide a solution capable of deciding a measuring voltage in such a way that a trade-off can be achieved between suppressing the interference from noises and saving power.

### SUMMARY OF THE INVENTION

An objective of the present invention is to provide a mechanism of dynamically adjusting a measuring voltage, which can both suppress the noises and save power by dynamically adjusting a measuring voltage according to a sensing signal.

To achieve the aforesaid objective, the present invention discloses a touch device. The touch device comprises a touch panel, a touch sensing circuit and a processing unit. The touch sensing circuit electrically connected to the touch panel is configured to provide a measuring voltage to the touch panel and sense the touch panel to generate a sensing signal. The processing unit electrically connected to the touch sensing circuit is configured to receive the sensing signal, calculate a first ratio according to the sensing signal and dynamically adjust the measuring voltage according to the first ratio.

The present invention further discloses a measuring voltage dynamic adjustment method for a touch device. The measuring voltage dynamic adjustment method comprises the following steps of: (a) receiving a sensing signal from a touch sensing circuit; (b) calculating a first ratio according to the sensing signal; and (c) dynamically adjusting a measuring voltage of the touch sensing circuit according to the first ratio.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view of a touch device 1 according to the present invention;

FIG. 2 is a diagram depicting sensing signals 102 generated corresponding to a same position of a touch panel 11 and sensed by a touch sensing circuit 13 within a time interval;

FIG. 3 is a schematic view depicting dynamic adjustment of a measuring voltage Vₘ according to a maximum offset S_{O};

FIG. 4 is a flowchart diagram of a measuring voltage dynamic adjustment method according to a second embodiment of the present invention; and

FIG. 5 is a flowchart diagram of a measuring voltage dynamic adjustment method according to a third embodiment of the present invention.

### DESCRIPTION OF THE PREFERRED EMBODIMENT

It shall be appreciated that, the following embodiments are only intended to exemplify the technical contents of the present invention, but not to limit the scope of the present invention. Furthermore, in the following embodiments and attached drawings, elements unrelated to the present invention are omitted from depiction; and dimensional relationships among the individual elements in the attached drawings are illustrated only for the ease of understanding, but not to limit the actual scale.

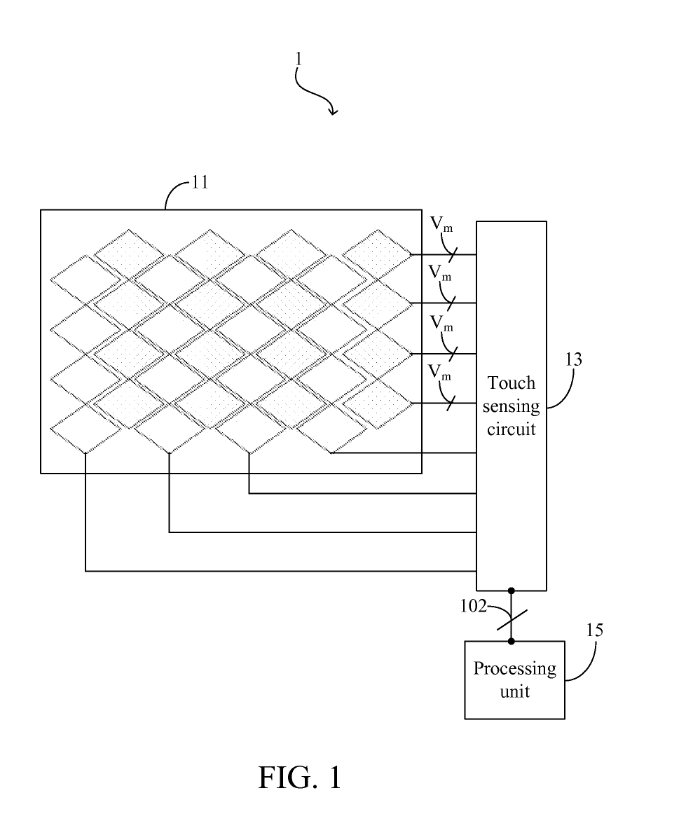

FIG. 1 depicts a touch device 1 according to a first embodiment of the present invention, which may be one of a mobile phone, a personal digital assistant (PDA) and a tablet computer or any other device with a touch function. The touch device 1 comprises a touch panel 11, a touch sensing circuit 13 and a processing unit 15. It should be appreciated that, for simplicity of description, other elements of the touch device 1 (e.g., a communication module, an input module, a power supply module and elements unrelated to the present invention) are omitted from depiction.

The touch panel 11 is a capacitive touch panel. The touch sensing circuit 13 is electrically connected to the touch panel 11 to provide a measuring voltage Vₘ to the touch panel 11. The touch sensing circuit 13 further senses a capacitance variation of the touch panel 11 to generate a sensing signal 102. The processing unit 15 is electrically connected to the touch sensing circuit 13. The processing unit 15 calculates a first ratio R according to the sensing signal 102, and dynamically adjusts the measuring voltage Vₘ according to the first ratio R.

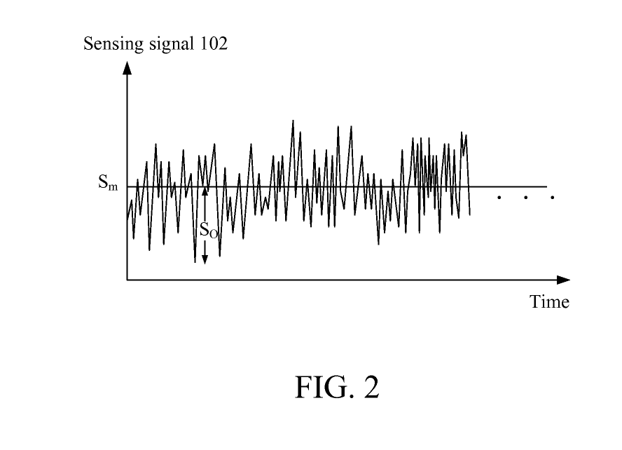

Specifically, the touch sensing circuit 13 continuously scans the touch panel 11 to sense the capacitance variation on the touch panel 11 in response to a touch from an object (e.g., a finger or a stylus). Therefore, the processing unit 15 receives sensing signals 102 of a plurality of sensing frames within a time interval. Then, the processing unit 15 calculates an average Sₘ of the sensing signals 102 corresponding to a same position in the sensing frames, and calculates a maximum offset S_{O} between the sensing signals 102 corresponding to the same position in the sensing frames and the average Sₘ respectively. FIG. 2 depicts sensing signals 102 generated corresponding to the same position of the touch panel 11 and sensed by the touch sensing circuit 13 within a time interval. It should be appreciated that, the aforesaid same position used to calculate the average Sₘ and the maximum offset S_{O} refers to a position where the sensing signal is greater than a threshold, i.e., a position of the touch panel 11 where the processor determines that a touch from an object exists. Finally, the processing unit 15 calculates a ratio of the average Sₘ to the maximum offset S_{O} as the first ratio R, i.e., R=Sₘ/S_{O}.

It should be appreciated that, as can be readily appreciated by those of ordinary skill in the art, the touch sensing circuit 13 may further comprise an analog-to-digital (A/D) converter, which is configured to convert the sensing signal 102 received from the touch panel 11 into a digital signal. In the present invention, the magnitude of the sensing signal 102 can represent an amount of variation in capacitance which is caused when the touch panel 11 is touched. Additionally, in this embodiment, the first ratio R is used to represent the signal to noise ratio (SNR) of the sensing signal 102. That is, the average Sₘ represents the magnitude of the signal, and the maximum offset S_{O} represents the magnitude of the noise. In this way, in order to make the first ratio R fall within a preset interval (e.g., from 10 to 20), the processing unit 15 can dynamically adjust the measuring voltage Vₘ according to the value of the first ratio R so that a too small value of the first ratio R which would lead to too large noise interferences on the sensing signal or a too large value of the first ratio R which would lead to excessive power consumption can be prevented.

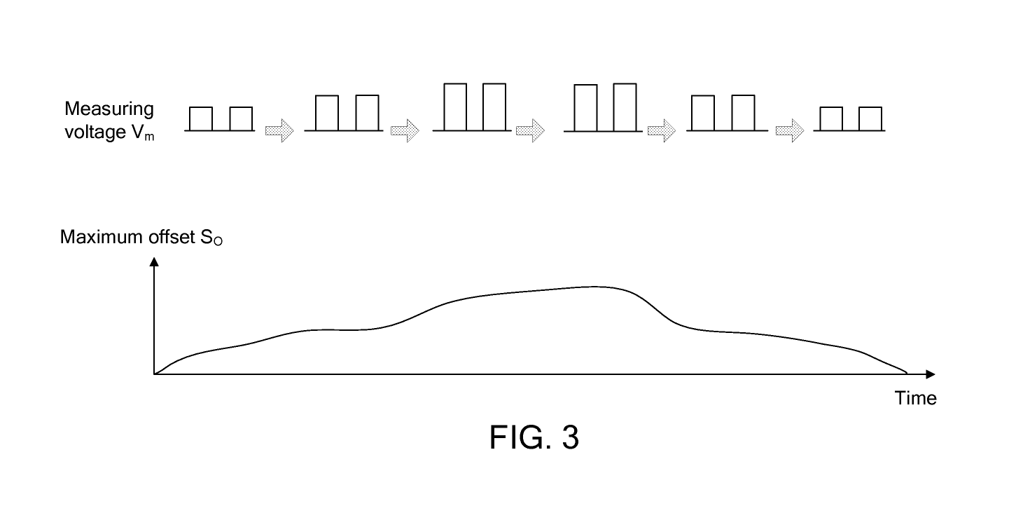

As shown in FIG. 3, in order to make the first ratio R fall within the preset interval, the measuring voltage Vₘ is increased as the offset S_{O} increases so as to suppress the interferences caused by the noise on the sensing signal 102. Thereafter, when the offset S_{O} decreases, the measuring voltage Vₘ is decreased accordingly to reduce unnecessary energy consumption and save power. It should be appreciated that, as can be appreciated by those of ordinary skill in the art based on the above descriptions, the present invention may also calculate the SNR as the first ratio through other technical means. Accordingly, obtaining the first ratio R through various technical means for calculating the SNR and dynamically adjusting the measuring voltage Vₘ according to the first ratio R are also covered within the scope of the present invention.

Several implementations of dynamically adjusting the measuring voltage Vₘ according to the present invention will be described hereinbelow. In an implementation, a lower threshold TH_{L} is defined in the processing unit 15. If the first ratio R is smaller than the lower threshold TH_{L}, then the measuring voltage Vₘ is increased by at least one unit voltage V_{d} until the first ratio R is greater than or equal to the lower threshold TH_{L}. For example, it is assumed that the measuring voltage Vₘ is 3.3 volts (V), the first ratio R is 8, the lower threshold TH_{L} is 10 and the unit voltage V_{d} is 1V. The processing unit 15 increases the measuring voltage Vₘ by 1V progressively until the first ratio R is greater than or equal to the lower threshold TH_{L}. In other words, the processing unit 15 determines whether the first ratio R is greater than or equal to the lower threshold TH_{L} every time the measuring voltage Vₘ is increased by 1V. Furthermore, the processing unit 15 can also calculate the amount by which the measuring voltage Vₘ needs to be increased according to a difference between the current first ratio R and the lower threshold TH_{L}. If the difference is greater than a reference value (e.g., the difference is 8 and the reference value is 3), then the measuring voltage Vₘ is increased by a plurality of unit voltages V_{d} (e.g., 5V, i.e., 5 unit voltages V_{d}) at a time. Thus, as compared with progressive adjustments, a one-time adjustment can greatly shorten the required adjustment time. In this way, the touch device 1 can effectively suppress the interferences from noises by increasing the measuring voltage Vₘ.

In another implementation, an upper threshold TH_{U} is defined in the processing unit 15. If the first ratio R is greater than the upper threshold TH_{U}, then the measuring voltage Vₘ is decreased by at least one unit voltage V_{d} until the first ratio R is smaller than or equal to the upper threshold TH_{U}. For example, it is assumed that the measuring voltage Vₘ is 12 volts (V), the first ratio R is 25, the upper threshold TH_{U} is 20, and the unit voltage V_{d} is 1V. The processing unit 15 decreases the measuring voltage Vₘ by 1V progressively until the first ratio R is smaller than or equal to the upper threshold TH_{U}. In other words, the processing unit 15 determines whether the first ratio R is smaller than or equal to the upper threshold TH_{U} every time the measuring voltage Vₘ is decreased by 1V. Furthermore, the processing unit 15 can also calculate the amount by which the measuring voltage Vₘ needs to be decreased according to a difference between the current first ratio R and the upper threshold TH_{U}, and decrease the measuring voltage Vₘ by a plurality of unit voltages V_{d} (e.g., 4V, i.e., 4 unit voltages V_{d}) at a time. In this way, the touch device 1 can effectively save power by decreasing the measuring voltage Vₘ.

In yet another implementation, both the upper threshold TH_{U} and the lower threshold Th_{U} are defined in the processing unit 15. If the first ratio is greater than the upper threshold TH_{U}, then the measuring voltage Vₘ is decreased by at least one unit voltage V_{d} so that the first ratio R is smaller than the lower threshold TH_{L}. If the first ratio R is smaller than the lower threshold TH_{L}, then the measuring voltage Vₘ is increased by one unit voltage V_{d} so that the first ratio R is greater than the lower threshold TH_{L}. For example, it is assumed that the measuring voltage Vₘ is 8 volts (V), the first ratio R is 25, the upper threshold TH_{U} is 20, the lower threshold Th_{U} is 10 and the unit voltage V_{d} is 1V. The processing unit 15 decreases the measuring voltage Vₘ by 1V progressively until the first ratio R is smaller than the lower threshold TH_{U}. In other words, the processing unit 15 determines whether the first ratio R is smaller than the lower threshold Th_{L} every time the measuring voltage Vₘ is decreased by 1V. Then, after the first ratio R is smaller than the lower threshold TH_{L}, the processing unit 15 increases the measuring voltage Vₘ by 1V so that the first ratio R is greater than or equal to the lower threshold TH_{L}. In this way, this mechanism of adjusting the measuring voltage Vₘ can both suppress the interferences from noises and save power by approximating the first ratio R to the lower threshold TH_{L}.

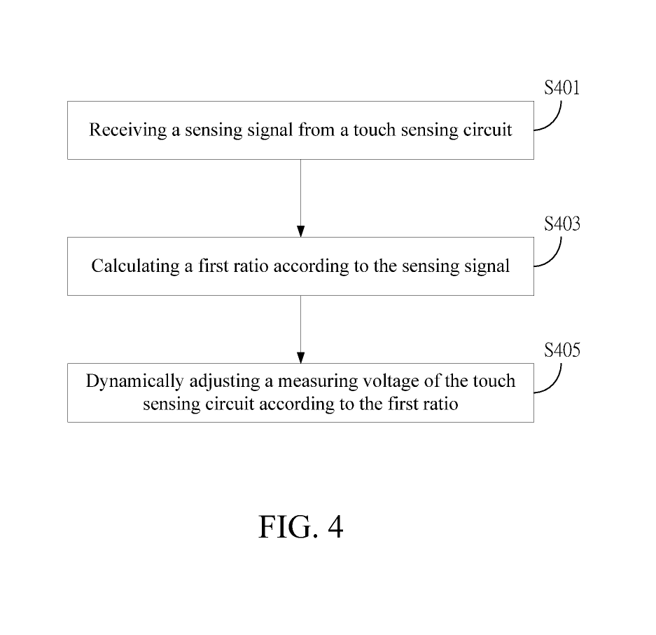

A second embodiment of the present invention is a measuring voltage dynamic adjustment method, a flowchart diagram of which is shown in FIG. 4. The measuring voltage dynamic adjustment method of the present invention is adapted for the processing unit 15 of the touch device 1 according to the first embodiment. The measuring voltage dynamic adjustment method of the present invention is for use in a touch device having a touch panel, a touch sensing circuit and a processing unit (e.g., the touch device 1 according to the first embodiment). The measuring voltage dynamic adjustment method according to this embodiment is executed by the processing unit of the touch device.

Firstly, in step S401, a sensing signal is received from a touch sensing circuit. Then, in step S403, a first ratio is calculated according to the sensing signal. Finally, in step S405, a measuring voltage of the touch sensing circuit is dynamically adjusted according to the first ratio.

Specifically, the dynamic adjustment of the measuring voltage described in the step S405 can be implemented by several implementations. In an implementation, if the first ratio is smaller than a lower threshold, then the measuring voltage is increased by at least one unit voltage until the first ratio is greater than or equal to the lower threshold. In another implementation, if the first ratio is greater than an upper threshold, then the measuring voltage is decreased by at least one unit voltage until the first ratio is smaller than the upper threshold.

Furthermore, in yet another implementation, if the first ratio is greater than an upper threshold, then the measuring voltage is decreased by at least one unit voltage so that the first ratio is smaller than a lower threshold; and if the first ratio is smaller than the lower threshold, then the measuring voltage is increased by one unit voltage so that the first ratio is greater than or equal to the lower threshold.

In addition to the aforesaid steps, the second embodiment can also execute all the operations and functions set forth in the first embodiment. How the measuring voltage dynamic adjustment method for a touch device according to the present invention executes these operations and functions will be readily appreciated by those of ordinary skill in the art based on the explanation of the first embodiment, and thus will not be further described herein.

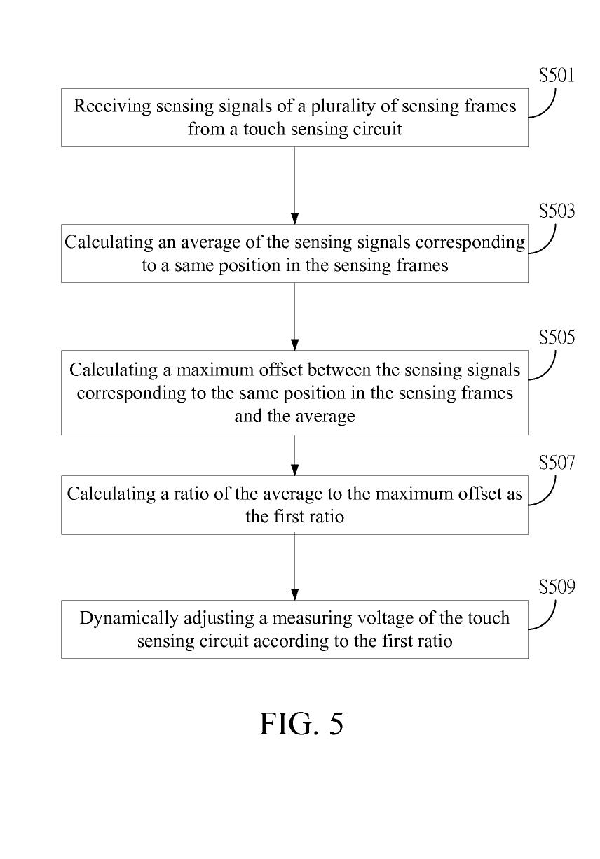

A third embodiment of the present invention is a measuring voltage dynamic adjustment method, a flowchart diagram of which is shown in FIG. 5. The measuring voltage dynamic adjustment method of the present invention is for use in a touch device having a touch panel, a touch sensing circuit and a processing unit (e.g., the touch device 1 according to the first embodiment). The measuring voltage dynamic adjustment method according to this embodiment is executed by the processing unit of the touch device.

Firstly, in step S501, sensing signals of a plurality of sensing frames are received from a touch sensing circuit. Then, in steps S503 and S505, an average of the sensing signals corresponding to a same position in the sensing frames is calculated, and a maximum offset between the sensing signals corresponding to the same position in the sensing frames and the average is calculated. Subsequently, in step S507, a ratio of the average to the maximum offset is calculated as a first ratio. Finally, in step S509, a measuring voltage of the touch sensing circuit is dynamically adjusted according to the first ratio.

Specifically, the dynamic adjustment of the measuring voltage described in the step S509 can be implemented by several implementations. In an implementation, if the first ratio is smaller than a lower threshold, then the measuring voltage is increased by at least one unit voltage until the first ratio is greater than or equal to the lower threshold. In another implementation, if the first ratio is greater than an upper threshold, then the measuring voltage is decreased by at least one unit voltage until the first ratio is smaller than the upper threshold. Furthermore, in yet another implementation, if the first ratio is greater than an upper threshold, then the measuring voltage is decreased by at least one unit voltage so that the first ratio is smaller than a lower threshold; and if the first ratio is smaller than the lower threshold, then the measuring voltage is increased by one unit voltage so that the first ratio is greater than or equal to the lower threshold.

In addition to the aforesaid steps, the third embodiment can also execute all the operations and functions set forth in the first embodiment. How the measuring voltage dynamic adjustment method for a touch device according to the present invention executes these operations and functions will be readily appreciated by those of ordinary skill in the art based on the explanation of the first embodiment, and thus will not be further described herein.

According to the above descriptions, the touch device and the measuring voltage dynamic adjustment method thereof according to the present invention dynamically adjust the measuring voltage according to the sensing signal generated by the touch panel. Therefore, as compared with the conventional touch devices, the touch device of the present invention can both suppress the interferences from noises and save power.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A touch device, comprising:
a touch panel;
a touch sensing circuit electrically connected to the touch panel, being configured to provide a measuring voltage to the touch panel and sense a capacitance variation of the touch panel to generate a sensing signal; and
a processing unit electrically connected to the touch sensing circuit, being configured to receive the sensing signal, calculate a first ratio according to the sensing signal, and dynamically adjust the measuring voltage according to the first ratio.

2. The touch device as claimed in claim 1, wherein the processing unit further receives sensing signals of a plurality of sensing frames, calculates an average of the sensing signals corresponding to a same position in the sensing frames, calculates a maximum offset between the sensing signals corresponding to the same position in the sensing frames and the average, and calculates a ratio of the average to the maximum offset as the first ratio.

3. The touch device as claimed in claim 1, wherein if the first ratio is smaller than a lower threshold, the processing unit increases the measuring voltage by at least one unit voltage until the first ratio is greater than or equal to the lower threshold.

4. The touch device as claimed in claim 3, wherein the processing unit compares a difference between the first ratio and the lower threshold with a reference value, and if the difference is greater than the reference value, then the measuring voltage is increased by a plurality of unit voltages so that the first ratio is greater than or equal to the lower threshold.

5. The touch device as claimed in claim 1, wherein if the first ratio is greater than an upper threshold, then the processing unit decreases the measuring voltage by at least one unit voltage until the first ratio is smaller than the upper threshold.

6. The touch device as claimed in claim 5, wherein the processing unit compares a difference between the first ratio and the upper threshold with a reference value, and if the difference is greater than the reference value, then the measuring voltage is decreased by a plurality of unit voltages so that the first ratio is smaller than the upper threshold.

7. The touch device as claimed in claim 1, wherein if the first ratio is greater than an upper threshold, then the processing unit decreases the measuring voltage by at least one unit voltage so that the first ratio is smaller than a lower threshold, and if the first ratio is smaller than the lower threshold, then the processing unit increases the measuring voltage by the unit voltage so that the first ratio is greater than or equal to the lower threshold.

8. A measuring voltage dynamic adjustment method for a touch device, comprising the following steps of:
(a) receiving a sensing signal from a touch sensing circuit;
(b) calculating a first ratio according to the sensing signal; and
(c) dynamically adjusting a measuring voltage of the touch sensing circuit according to the first ratio.

9. The measuring voltage dynamic adjustment method as claimed in claim 8, wherein the step (a) further comprises the following step of:
receiving sensing signals of a plurality of sensing frames;
and the step (b) further comprises the following steps of:
calculating an average of the sensing signals corresponding to a same position in the sensing frames;
calculating a maximum offset between the sensing signals corresponding to the same position in the sensing frames and the average; and
calculating a ratio of the average to the maximum offset as the first ratio.

10. The measuring voltage dynamic adjustment method as claimed in claim 8, wherein the step (c) further comprises the following step of:
if the first ratio is smaller than a lower threshold, then increasing the measuring voltage by at least one unit voltage until the first ratio is greater than or equal to the lower threshold.

11. The measuring voltage dynamic adjustment method as claimed in claim 10, wherein the step (c) further comprises the following step of:
comparing a difference between the first ratio and the lower threshold with a reference value, and if the difference is greater than the reference value, then increasing the measuring voltage by a plurality of unit voltages so that the first ratio is greater than or equal to the lower threshold.

12. The measuring voltage dynamic adjustment method as claimed in claim 8, wherein the step (c) further comprises the following step of:
if the first ratio is greater than an upper threshold, then decreasing the measuring voltage by at least one unit voltage until the first ratio is smaller than the upper threshold.

13. The measuring voltage dynamic adjustment method as claimed in claim 12, wherein the step (c) further comprises the following step of:
comparing a difference between the first ratio and the upper threshold with a reference value, and if the difference is greater than the reference value, then decreasing the measuring voltage by a plurality of unit voltages so that the first ratio is smaller than the upper threshold.

14. The measuring voltage dynamic adjustment method as claimed in claim 8, wherein the step (c) further comprises the following steps of:
if the first ratio is greater than an upper threshold, then decreasing the measuring voltage by at least one unit voltage so that the first ratio is smaller than a lower threshold; and
if the first ratio is smaller than the lower threshold, then increasing the measuring voltage by the unit voltage so that the first ratio is greater than or equal to the lower threshold.
